(19) United States
(12) Patent Application Publication
(10) Pub. No.: US 2024/0009640 A1
(43) Pub. Date: Jan. 11, 2024

(54) MICROBIAL REPAIRING AGENT PRODUCTION LINE AND PRODUCTION PROCESS BASED ON SAME

(71) Applicant: SOUTHEAST UNIVERSITY, Nanjing (CN)

(72) Inventors: Chunxiang QIAN, Nanjing (CN); Tianwen ZHENG, Nanjing (CN)

(73) Assignee: SOUTHEAST UNIVERSITY, Nanjing (CN)

(21) Appl. No.: 18/230,732

(22) Filed: Aug. 7, 2023

Related U.S. Application Data
(63) Continuation of application No. PCT/CN2022/106933, filed on Jul. 21, 2022.

(30) Foreign Application Priority Data
Mar. 24, 2022 (CN) 202210292526.6

(51) Int. Cl. B01J 2/12; B02C 23/10

(52) U.S. Cl. CPC B01J 2/12; B02C 23/10

(57) ABSTRACT

A microbial repairing agent production line includes a feeder, where the feeder is connected to a storage bin, the bottom of the storage bin is connected to a metering tank, the metering tank is in communication with a granulator through a spiral or pneumatic conveying apparatus, a screening device is arranged below the granulator, and a discharge port of the screening device is connected to one end of a conveyor belt; a production process for includes: conveying a raw material to a storage bin through a feeder; then adding the raw materials to a metering tank in sequence through a spiral or pneumatic conveying apparatus, and metering and weighing the raw materials; conveying metered raw materials into a granulator; discharging the microbial repairing agent; and screening the microbial repairing agent, and collecting and maintaining the microbial repairing agent.

### CROSS-REFERENCE TO RELATED APPLICATIONS

This application is the Continuation application of International Application No. PCT/CN2022/106933 filed on 21 Jul. 2022 which designated the U.S. and claims priority to Chinese Application No. CN202210292526.6 filed on 24 Mar. 2022, the entire contents of each of which are hereby incorporated by reference.

### TECHNICAL FIELD

The present invention relates to a production line and a production process based on same, in particular to a concrete crack repairing based microbial repairing agent production line and a production process based on same.

### BACKGROUND ART

Globally, concrete has been frequently applied in a wide range over other building materials due to its high compressive strength, desirable durability, easy availability of raw materials, a low cost, etc. However, with high brittleness, low tensile strength, large shrinkage deformation, etc. a concrete material will inevitably be vulnerable to cracks in its use process, greatly affecting the attractiveness and functionality of a building. Moreover, under the impact of cracks, water resistance, a bearing capacity, and use safety of a concrete structure will be affected, steel bars will be corroded, and an alkali-aggregate reaction and carbonization will also be accelerated. Accordingly, the concrete structure is degraded in durability and shortened in service life.

Microbial self-repairing concrete means the mixture obtained after a microbial repairing agent satisfying requirements is added to concrete in a certain way. When cracks are generated in the concrete, air, water, and so forth in the natural environment enter the cracks to activate microorganisms in a dormant state. Calcium carbonate with good compatibility with a cement-based material is induced to be generated under a mineralization action of the microorganisms and then effectively fills the cracks. Accordingly, substance exchange between the interior of the concrete and the external environment is inhibited, so that concrete crack self-repairing is realized, the service life of the concrete is prolonged, and the durability of the concrete is improved.

Under the impact of high alkalinity and continuously-dense pore structures in the concrete, even spores having strong alkali resistance can hardly survive for a long time, which reduces a concrete crack self-repairing effect in a later stage. Therefore, a microbial repairing agent with a core-shell structure must be prepared for loaded protection on microbial spores. However, with semi-automatic and manual operation and a low production efficiency, a conventional sugar-coating technology can only be used to prepare a small quantity of microbial repairing agents, but large-scale and automatic production is impossible, which is not conducive to batch preparation and application of microbial repairing agents.

### SUMMARY

Invention objective: an objective of the present invention is to provide a microbial repairing agent production line and a production process based on same. Accordingly, microbial repairing agents can be prepared automatically in batch, product performance is desirable, labor intensity is greatly reduced, and a production efficiency is significantly improved.

Technical solution: the present invention includes a feeder, where the feeder is connected to a storage bin, the bottom of the storage bin is connected to a metering tank, the metering tank is in communication with a granulator, a screening device is arranged below the granulator, and a discharge port of the screening device is connected to one end of a conveyor belt.

The granulator includes a granulation cylinder, the top of the granulation cylinder is provided with a cylinder cover, the bottom of the granulation cylinder is provided with a discharge port, the discharge port is connected to a discharging mechanism, a transmission system is arranged in the granulation cylinder, and a scraper assembly is arranged on an inner wall of the granulation cylinder.

The transmission system includes a rotor transmission system and a granulation tray transmission system, and the granulation tray transmission system and the rotor transmission system are opposite in transmission directions, so that materials are fully mixed.

The scraper assembly includes a side scraping plate blade and a bottom scraping plate blade. Therefore, materials remaining at an edge and bottom of the granulation cylinder can be conveyed to the granulator, and the materials can be discharged in a short time after a granulation cycle is ended.

The discharging mechanism employs a hydraulic drive mode, a hydraulic pump station arranged at the bottom of the granulator drives a swing arm to swing back and forth, and the swing arm is driven through a transmission shaft to open and close a discharging door.

The cylinder cover is provided with an observation port, a feed port, and a liquid addition port, the feed port is connected to a pneumatic conveying apparatus, and the liquid addition port is connected to a water supply system.

A dust removal device is mounted at the top of the storage bin, and a vibrator is mounted on a side surface of the storage bin to prevent the raw materials from caking.

A vibrator is mounted on one side of the metering tank to prevent the raw materials from remaining on a tank body.

The screening device employs multiple layers of screens having different particle sizes. During screening, a screening frequency can be controlled by controlling the vibrator below a vibration screen.

A microbial repairing agent production process includes:
(1) conveying a raw material to a storage bin through a feeder and a spiral or pneumatic conveying apparatus;
(2) adding the raw materials in the storage bin to a metering tank in sequence through the spiral or pneumatic conveying apparatus, and metering and weighing the raw materials;
(3) conveying metered raw materials into a granulator through the spiral or pneumatic conveying apparatus, and controlling a water addition amount and granulation time to obtain a microbial repairing agent;
(4) discharging the microbial repairing agent through a discharging system at the bottom of the granulator after granulation is completed; and
(5) screening the microbial repairing agent through a screening device to obtain a microbial repairing agent having a required particle size, and collecting and maintaining the microbial repairing agent through a conveyor belt.

Beneficial effect: the present invention is highly mechanized and automated, can realize large-scale and continuous production, reduce labor intensity, and improve the production efficiency. The prepared microbial repairing agent has uniform particles and stable performance. The microbial repairing agents can be produced in batch with a monthly output up to 300 t to 500 t after the above production line is employed.

### BRIEF DESCRIPTION OF THE DRAWINGS

FIG. 1 is a three-dimensional schematic stereogram of an overall structure according to the present invention;

FIG. 2 is a left-view schematic diagram of an overall structure according to the present invention;

FIG. 3 is a schematic structural diagram of a granulator according to the present invention;

FIG. 4 is a sectional view of an internal structure of a granulator;

FIG. 5 is a top view of a granulator according to the present invention; and

FIG. 6 is a sample prepared through a microbial repairing agent production line.

### DETAILED DESCRIPTION OF THE EMBODIMENTS

The present invention will be further described below with reference to the accompanying drawings.

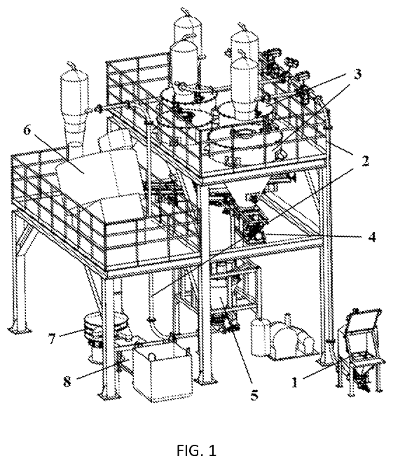

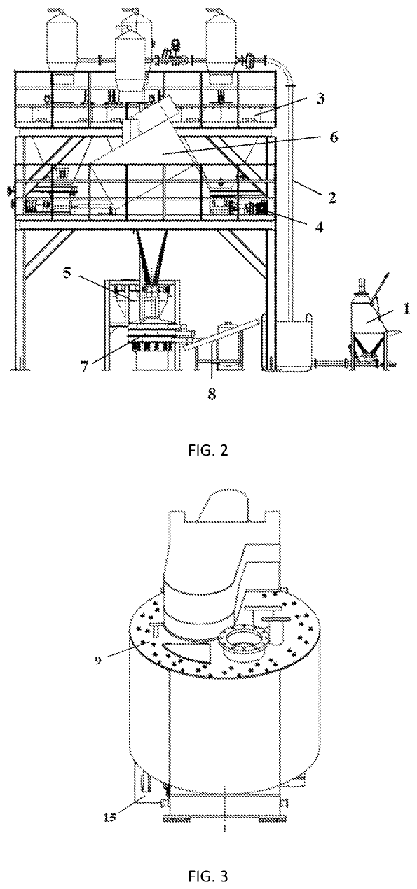

As shown in FIGS. 1 and 2, the present invention includes a feeder 1, a pneumatic conveying apparatus 2, a storage bin 3, a spiral conveying apparatus 4, a metering tank 5, a granulator 6, a screening device 7, and a conveyor belt 8, where the feeder 1 is connected to the storage bin 3 through the pneumatic conveying apparatus 2 or the spiral conveying apparatus 4, the bottom of the storage bin 3 is connected to the metering tank 5 through the pneumatic conveying apparatus 2 or the spiral conveying apparatus 4, the metering tank 5 is in communication with the granulator 6 through the pneumatic conveying apparatus 2 or the spiral conveying apparatus 4, the screening device 7 is arranged below the granulator 6, and a discharge port of the screening device 7 is connected to one end of the conveyor belt 8, so that a full-automatic production line can be formed.

The feeder 1 is a stainless steel apparatus capable of dust removal and noise avoidance, with a feeding speed of 1 kg/min-3 kg/min. The pneumatic conveying apparatus 2 is realized through a negative pressure and requires desirable pipeline tightness. Four storage bins 3 in two specifications are provided. A largest 3-L storage bin stores low-alkaline sulphoaluminate cement, and three 1-L storage bins store a counterweight substance, microbial bacterial powder A, and microbial bacterial powder B respectively. The four storage bins ensure the supply of raw materials during large-scale operation of the production line. Moreover, a dust removal device is mounted at the top of the storage bin 3, so that dust pollution to an external environment is effectively avoided. A vibrator is mounted on a side surface of the storage bin to prevent the raw materials from caking. An electric motor of the spiral conveying apparatus 4 can directly drive a flywheel to move forwards and reversely, with a rotation speed of 30 r/min-60 r/min. No dust or blockage is generated in a raw material process. The 1-L metering tank 5 employs a static metering mode and has desirable tightness. A vibrator is mounted on one side of a metering tank wall to prevent raw materials from remaining on a tank body. The screening device 7 consists of three layers of screens having different particle sizes, where the particle sizes are 3.2 mm-4.0 mm, 2.0 mm-2.5 mm, and 1.0 mm-1.5 mm from top to bottom. During screening, a screening frequency can be controlled by controlling the vibrator below a vibration screen. The conveyor belt 8 can be fixed and moved at any time to convey a microbial repairing agent product at a speed of 0.2 m/s. After the above structure is employed, a position of the conveyor belt 8 can be adjusted at any time. Therefore, the microbial repairing agent can be automatically conveyed, a labor cost is reduced, and a conveying efficiency is improved.

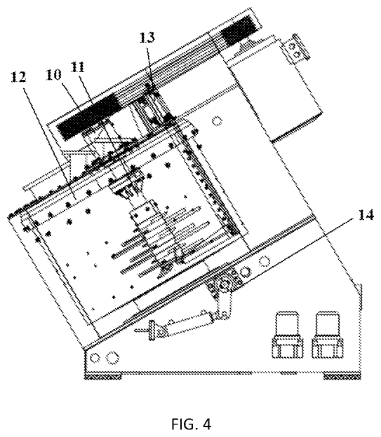

As shown in FIGS. 3-5, the granulator 6 is a full-automatic inclined-type strong granulator and includes a transmission system, a water supply system, a granulation cylinder 12, a cylinder cover 9, and a discharging mechanism 14. The top of the granulation cylinder 12 is provided with the cylinder cover 9, and the bottom of the granulation cylinder is provided with a discharge port; the discharge port is connected to a discharging mechanism 14, and a valve is arranged at the discharge port to adjust a discharge amount; and granulation time is 20 min-30 min. The transmission system is arranged in the granulation cylinder 12 and includes a rotor transmission system 11 and a granulation tray transmission system 10. During granulation, the granulation tray transmission system 10 and the rotor transmission system 11 are opposite in transmission directions to ensure full mixing of the materials. A rotation speed can be up to 200 rpm-500 rpm. A scraper assembly 13 is arranged on an inner wall of the granulation cylinder 12, and the scraper assembly 13 can be divided into a side scraping plate blade and a bottom scraping plate blade. Therefore, the materials remaining at an edge and the bottom of the granulation cylinder 12 can be conveyed to the granulator, and the materials can be discharged in a short time after a granulation cycle is ended. The discharging mechanism 14 employs a hydraulic drive mode, a hydraulic pump station 15 arranged at the bottom of the granulator controls an oil cylinder to stretch and retract to drive a swing arm to swing back and forth, and the swing arm is driven through a transmission shaft to open and close a discharging door.

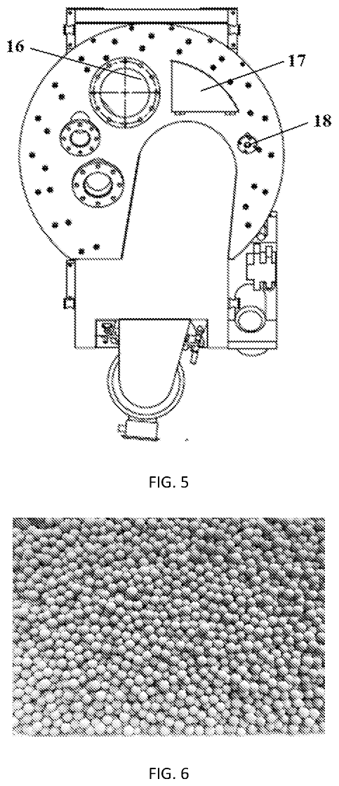

As shown in FIG. 5, the cylinder cover 9 is provided with an observation port 17, a feed port 16, and a liquid addition port 18. The feed port 16 is connected to the pneumatic conveying apparatus 2 for conveying the material from the metering tank 5 to the granulator 6 for granulation. The observation port 17 can be opened and closed and configured to observe a spherical change during granulation. The liquid addition port 18 is connected to the water supply system and configured to control a water usage amount during granulation. The water supply system includes a water pipe, a valve, a water storage box, and a flow meter. The water addition amount can be controlled through the flow meter. The water supply system employs a double-pipeline mode. Therefore, in one aspect, a pipeline is directly connected to a water source and controlled to be opened and closed through the valve, and water enters the full-automatic granulator via the flow meter; and in the other aspect, water is pre-stored in a 2-L water box, and then a water pump pumps water to flow through the flow meter along a pipeline and then enter the full-automatic granulator. In the double-pipeline water supply mode, shutdown of the production line caused by sudden water source supply failure can be avoided, and a production efficiency of the microbial repairing agent can be ensured.

The discharging system employs a hydraulic drive discharge mode, and a discharging amount is controlled through the valve. The water addition amount is controlled to range from 3% to 8% of the total mass of the raw materials, and the granulation time is 20 min-30 min.

The present invention can prepare the microbial repairing agent having a uniform particle size, stable performance, and desirable sphericity in batch. The microbial repairing agent is automatically produced in batch, so that labor intensity is greatly reduced, and the production efficiency is improved.

A microbial repairing agent production process includes:
(1) a raw material is conveyed to a storage bin through a feeder and a spiral or pneumatic conveying apparatus at a certain speed;
(2) the raw materials in the storage bin are added to a metering tank in sequence through the spiral or pneumatic conveying apparatus and then metered and weighed;
(3) metered raw materials are conveyed into a full-automatic granulator through the spiral or pneumatic conveying apparatus, and a water addition amount and granulation time are controlled to obtain a microbial repairing agent having a certain particle size;
(4) a discharge amount is controlled through a valve at a lower end of the granulator, and the microbial repairing agent is discharged through a discharging system after granulation is completed;
(5) a vibration frequency is rationally controlled, and the microbial repairing agent is screened through a screening device to obtain a microbial repairing agent having a required particle size; and
(6) the microbial repairing agent is collected and maintained through a mobile conveyor belt connected to a discharge port of the screening device.

Through the above process employed, the microbial repairing agent having a uniform particle size and desirable performance can be obtained, as shown in FIG. 6. Moreover, a production efficiency is improved, and labor intensity and a preparation cost are reduced.

What is claimed is:

1. A microbial repairing agent production line, comprising a feeder (1), wherein the feeder (1) is connected to a storage bin (3), the bottom of the storage bin (3) is connected to a metering tank (5), the metering tank (5) is in communication with a granulator (6), a screening device (7) is arranged below the granulator (6), and a discharge port of the screening device (7) is connected to one end of a conveyor belt (8).

2. The microbial repairing agent production line according to claim 1, wherein the granulator (6) comprises a granulation cylinder (12), the top of the granulation cylinder (12) is provided with a cylinder cover (9), the bottom of the granulation cylinder is provided with a discharge port, the discharge port is connected to a discharging mechanism (14), a transmission system is arranged in the granulation cylinder (12), and a scraper assembly (13) is arranged on an inner wall of the granulation cylinder (12).

3. The microbial repairing agent production line according to claim 2, wherein the transmission system comprises a rotor transmission system (11) and a granulation tray transmission system (10), and the granulation tray transmission system (10) and the rotor transmission system (11) are opposite in transmission directions.

4. The microbial repairing agent production line according to claim 2, wherein the scraper assembly (13) comprises a side scraping plate blade and a bottom scraping plate blade.

5. The microbial repairing agent production line according to claim 2, wherein the discharging mechanism (14) employs a hydraulic drive mode, and a hydraulic pump station (15) arranged at the bottom of the granulator drives a swing arm to swing back and forth.

6. The microbial repairing agent production line according to claim 2, wherein the cylinder cover (9) is provided with an observation port (17), a feed port (16), and a liquid addition port (18), the feed port (16) is connected to a pneumatic conveying apparatus (2), and the liquid addition port (18) is connected to a water supply system.

7. The microbial repairing agent production line according to claim 1, wherein a dust removal device is mounted at the top of the storage bin (3), and a vibrator is mounted on a side surface of the storage bin.

8. The microbial repairing agent production line according to claim 1, wherein a vibrator is mounted on one side of the metering tank (5).

9. The microbial repairing agent production line according to claim 1, wherein the screening device (7) employs multiple layers of screens having different particle sizes.

10. A production process based on the microbial repairing agent production line according to claim 1, comprising:
(i) conveying a raw material to a storage bin through a feeder;
(ii) adding the raw materials in the storage bin to a metering tank in sequence through a spiral or pneumatic conveying apparatus, and metering and weighing the raw materials;
(iii) conveying metered raw materials into a granulator, and controlling a water addition amount and granulation time to obtain a microbial repairing agent;
(iv) discharging the microbial repairing agent through a discharging system at the bottom of the granulator after granulation is completed; and
(v) screening the microbial repairing agent through a screening device to obtain a microbial repairing agent having a required particle size, and collecting and maintaining the microbial repairing agent through a conveyor belt.
